(19) United States
(12) Patent Application Publication
(10) Pub. No.: US 2025/0280370 A1
(43) Pub. Date: Sep. 4, 2025

(54) POWER HEADROOM REPORTING ASSOCIATED WITH SIMULTANEOUS TRANSMISSIONS ON A PLURALITY OF UPLINK CHANNELS

(71) Applicant: QUALCOMM Incorporated, San Diego, CA (US)

(72) Inventors: Fang YUAN, Beijing (CN); Yan ZHOU, San Diego, CA (US); Tao LUO, San Diego, CA (US)

(21) Appl. No.: 18/858,973

(22) PCT Filed: Jul. 7, 2022
(86) PCT No.: PCT/CN2022/104327

§ 371 Date: Oct. 22, 2024

(51) Int. Cl. H04W 52/36; H04W 72/21

(52) U.S. Cl. CPC H04W 52/365; H04W 52/367; H04W 72/21

(57) ABSTRACT

Various aspects of the present disclosure generally relate to wireless communication. In some aspects, a user equipment (UE) may receive configuration information corresponding to power headroom reporting associated with simultaneous transmissions on a plurality of uplink channels, the configuration information indicating a maximum total transmit power limit associated with the simultaneous transmissions. The UE may transmit, based at least in part on the configuration information, a medium access control (MAC) control element (MAC CE) that includes at least one power headroom report corresponding to the plurality of uplink channels. Numerous other aspects are described.

### FIELD OF THE DISCLOSURE

Aspects of the present disclosure generally relate to wireless communication and to techniques and apparatuses for power headroom reporting associated with simultaneous transmissions on a plurality of uplink channels.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a user equipment (UE) for wireless communication. The UE may include a memory and one or more processors coupled to the memory. The one or more processors may be configured to receive configuration information corresponding to power headroom reporting associated with simultaneous transmissions on a plurality of uplink channels, the configuration information indicating a maximum total transmit power limit associated with the simultaneous transmissions. The one or more processors may be configured to transmit, based at least in part on the configuration information, a medium access control (MAC) control element (MAC CE) that includes at least one power headroom report (PHR) corresponding to the plurality of uplink channels.

Some aspects described herein relate to a network node for wireless communication. The network node may include a memory and one or more processors coupled to the memory. The one or more processors may be configured to transmit configuration information corresponding to power headroom reporting associated with simultaneous transmissions on a plurality of uplink channels, the configuration information indicating a maximum total transmit power limit associated with the simultaneous transmissions. The one or more processors may be configured to receive, based at least in part on the configuration information, a MAC CE that includes at least one PHR corresponding to the plurality of uplink channels.

Some aspects described herein relate to a method of wireless communication performed by a UE. The method may include receiving configuration information corresponding to power headroom reporting associated with simultaneous transmissions on a plurality of uplink channels, the configuration information indicating a maximum total transmit power limit associated with the simultaneous transmissions. The method may include transmitting, based at least in part on the configuration information, a MAC CE that includes at least one PHR corresponding to the plurality of uplink channels.

Some aspects described herein relate to a method of wireless communication performed by a network node. The method may include transmitting configuration information corresponding to power headroom reporting associated with simultaneous transmissions on a plurality of uplink channels, the configuration information indicating a maximum total transmit power limit associated with the simultaneous transmissions. The method may include receiving, based at least in part on the configuration information, a MAC CE that includes at least one PHR corresponding to the plurality of uplink channels.

Some aspects described herein relate to a non-transitory computer-readable medium that stores a set of instructions for wireless communication by a UE. The set of instructions, when executed by one or more processors of the UE, may cause the UE to receive configuration information corresponding to power headroom reporting associated with simultaneous transmissions on a plurality of uplink channels, the configuration information indicating a maximum total transmit power limit associated with the simultaneous transmissions. The set of instructions, when executed by one or more processors of the UE, may cause the UE to transmit, based at least in part on the configuration information, a MAC CE that includes at least one PHR corresponding to the plurality of uplink channels.

Some aspects described herein relate to a non-transitory computer-readable medium that stores a set of instructions for wireless communication by a network node. The set of instructions, when executed by one or more processors of the network node, may cause the network node to transmit configuration information corresponding to power headroom reporting associated with simultaneous transmissions on a plurality of uplink channels, the configuration information indicating a maximum total transmit power limit associated with the simultaneous transmissions. The set of instructions, when executed by one or more processors of the network node, may cause the network node to receive, based at least in part on the configuration information, a MAC CE that includes at least one PHR corresponding to the plurality of uplink channels.

Some aspects described herein relate to an apparatus for wireless communication. The apparatus may include means for receiving configuration information corresponding to power headroom reporting associated with simultaneous transmissions on a plurality of uplink channels, the configuration information indicating a maximum total transmit power limit associated with the simultaneous transmissions. The apparatus may include means for transmitting, based at least in part on the configuration information, a MAC CE that includes at least one PHR corresponding to the plurality of uplink channels.

Some aspects described herein relate to an apparatus for wireless communication. The apparatus may include means for transmitting configuration information corresponding to power headroom reporting associated with simultaneous transmissions on a plurality of uplink channels, the configuration information indicating a maximum total transmit power limit associated with the simultaneous transmissions. The apparatus may include means for receiving, based at least in part on the configuration information, a MAC CE that includes at least one PHR corresponding to the plurality of uplink channels.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of single-cell maximum permissible exposure reporting using a power headroom report (PHR) of a medium access control (MAC) control element (MAC CE), in accordance with the present disclosure.

FIG. 5 is a diagram illustrating examples of MPE reports for multi-cell, single-panel PHR reporting.

FIG. 6 is a diagram illustrating an example associated with power headroom reporting associated with simultaneous transmission on a plurality of uplink channels, in accordance with the present disclosure.

FIG. 7 is a diagram illustrating an example of a MAC CE having two PHRs, in accordance with the present disclosure.

FIG. 8 is a diagram illustrating an example of a MAC CE having two PHRs, in accordance with the present disclosure.

FIG. 9 is a diagram illustrating an example of a MAC CE having two PHRs, in accordance with the present disclosure.

FIG. 10 is a diagram illustrating an example process performed, for example, by a UE, in accordance with the present disclosure.

FIG. 11 is a diagram illustrating an example process performed, for example, by a network node, in accordance with the present disclosure.

FIG. 12 is a diagram of an example apparatus for wireless communication, in accordance with the present disclosure.

FIG. 13 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Aspects and examples generally include a method, apparatus, network node, system, computer program product, non-transitory computer-readable medium, user equipment, base station, wireless communication device, and/or processing system as described or substantially described herein with reference to and as illustrated by the drawings and specification.

This disclosure may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, are better understood from the following description when considered in connection with the accompanying figures. Each of the figures is provided for the purposes of illustration and description, and not as a definition of the limits of the claims.

While aspects are described in the present disclosure by illustration to some examples, such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component-based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). Aspects described herein may be practiced in a wide variety of devices, components, systems, distributed arrangements, and/or end-user devices of varying size, shape, and constitution.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

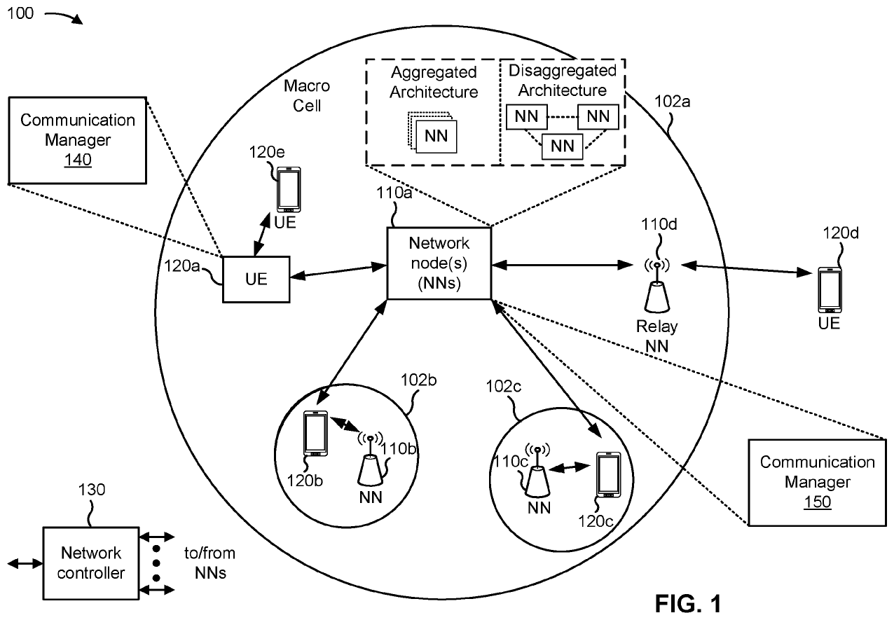

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an ITE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the term “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the term “base station” or “network node” may refer to one device configured to perform one or more functions, such as those described herein in connection with the network node 110. In some aspects, the term “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the term “base station” or “network node” may refer to any one or more of those different devices. In some aspects, the term “base station” or “network node” may refer to one or more virtual base stations or one or more virtual base station functions. For example, in some aspects, two or more base station functions may be instantiated on a single device. In some aspects, the term “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a UE (e.g., the UE 120) may include a communication manager 140. As described in more detail elsewhere herein, the communication manager 140 may receive configuration information corresponding to power headroom reporting associated with simultaneous transmissions on a plurality of uplink channels, the configuration information indicating a maximum total transmit power limit associated with the simultaneous transmissions; and transmit, based at least in part on the configuration information, a medium access control (MAC) control element (MAC CE) that includes at least one power headroom report (PHR) corresponding to the plurality of uplink channels. Additionally, or alternatively, the communication manager 140 may perform one or more other operations described herein.

In some aspects, a network node (e.g., the network node 110) may include a communication manager 150. As described in more detail elsewhere herein, the communication manager 150 may transmit configuration information corresponding to power headroom reporting associated with simultaneous transmissions on a plurality of uplink channels, the configuration information indicating a maximum total transmit power limit associated with the simultaneous transmissions; and receive, based at least in part on the configuration information, a MAC CE that includes at least one PHR corresponding to the plurality of uplink channels. Additionally, or alternatively, the communication manager 150 may perform one or more other operations described herein.

As indicated above, FIG. 1 is provided as an example. Other examples may differ from what is described with regard to FIG. 1.

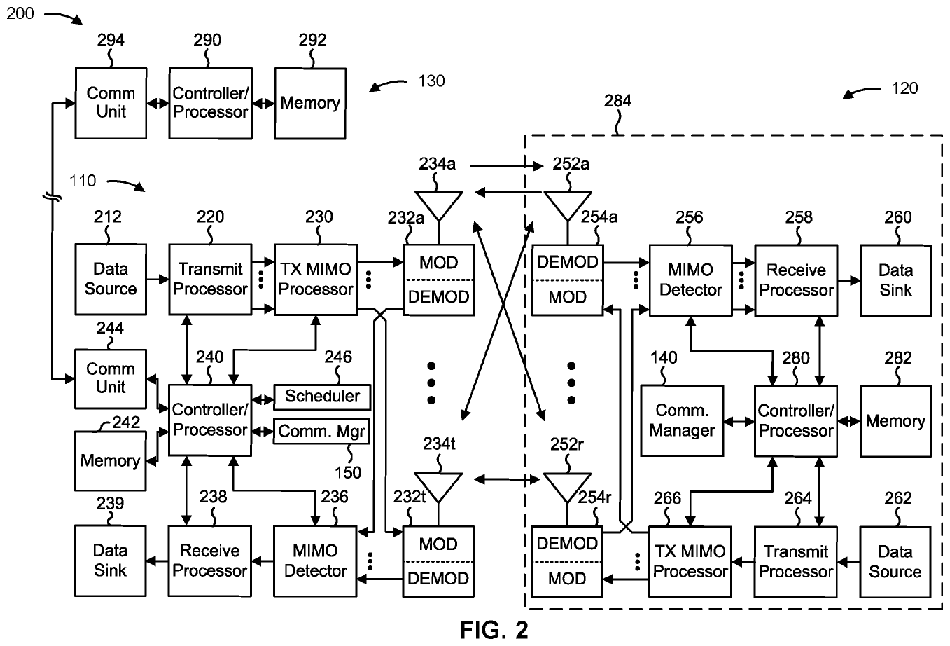

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

Each of the antenna elements may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, or other types of antennas arranged in a linear pattern, a two-dimensional pattern, or another pattern. A spacing between antenna elements may be such that signals with a desired wavelength transmitted separately by the antenna elements may interact or interfere (e.g., to form a desired beam). For example, given an expected range of wavelengths or frequencies, the spacing may provide a quarter wavelength, half wavelength, or other fraction of a wavelength of spacing between neighboring antenna elements to allow for interaction or interference of signals transmitted by the separate antenna elements within that expected range.

Antenna elements and/or sub-elements may be used to generate beams. “Beam” may refer to a directional transmission such as a wireless signal that is transmitted in a direction of a receiving device. A beam may include a directional signal, a direction associated with a signal, a set of directional resources associated with a signal (e.g., angle of arrival, horizontal direction, vertical direction), and/or a set of parameters that indicate one or more aspects of a directional signal, a direction associated with a signal, and/or a set of directional resources associated with a signal.

As indicated above, antenna elements and/or sub-elements may be used to generate beams. For example, antenna elements may be individually selected or deselected for transmission of a signal (or signals) by controlling an amplitude of one or more corresponding amplifiers. Beamforming includes generation of a beam using multiple signals on different antenna elements, where one or more, or all, of the multiple signals are shifted in phase relative to each other. The formed beam may carry physical or higher layer reference signals or information. As each signal of the multiple signals is radiated from a respective antenna element, the radiated signals interact, interfere (constructive and destructive interference), and amplify each other to form a resulting beam. The shape (such as the amplitude, width, and/or presence of side lobes) and the direction (such as an angle of the beam relative to a surface of an antenna array) can be dynamically controlled by modifying the phase shifts or phase offsets of the multiple signals relative to each other.

Beamforming may be used for communications between a UE and a network node, such as for millimeter wave communications and/or the like. In such a case, the network node may provide the UE with a configuration of transmission configuration indicator (TCI) states that respectively indicate beams that may be used by the UE, such as for receiving a physical downlink shared channel (PDSCH). The network node may indicate an activated TCI state to the UE, which the UE may use to select a beam for receiving the PDSCH.

A beam indication may be, or include, a TCI state information element, a beam identifier (ID), spatial relation information, a TCI state ID, a closed loop index, a panel ID, a TRP ID, and/or a sounding reference signal (SRS) set ID, among other examples. A TCI state information element (referred to as a TCI state herein) may indicate information associated with a beam such as a downlink beam. For example, the TCI state information element may indicate a TCI state identification (e.g., a tci-StateID), a quasi-co-location (QCL) type (e.g., a qcl-Type1, qcl-Type2, qel-TypeA, qcl-TypeB, qcl-TypeC, qcl-TypeD, and/or the like), a cell identification (e.g., a ServCellIndex), a bandwidth part identification (bwp-Id), a reference signal identification such as a CSI-RS (e.g., an NZP-CSI-RS-ResourceId, an SSB-Index, and/or the like), and/or the like. Spatial relation information may similarly indicate information associated with an uplink beam.

The beam indication may be a joint or separate downlink (DL)/uplink (UL) beam indication in a unified TCI framework. In some cases, the network may support layer 1 (L1)-based beam indication using at least UE-specific (unicast) downlink control information (DCI) to indicate joint or separate DL/UL beam indications from active TCI states. In some cases, existing DCI formats 1_1 and/or 1_2 may be reused for beam indication. The network may include a support mechanism for a UE to acknowledge successful decoding of a beam indication. For example, the acknowledgment/negative acknowledgment (ACK/NACK) of the PDSCH scheduled by the DCI carrying the beam indication may be also used as an ACK for the DCI.

Beam indications may be provided for carrier aggregation (CA) scenarios. In a unified TCI framework, information the network may support common TCI state ID update and activation to provide common QCL and/or common UL transmission spatial filter or filters across a set of configured component carriers (CCs). This type of beam indication may apply to intra-band CA, as well as to joint DL/UL and separate DL/UL beam indications. The common TCI state ID may imply that one reference signal (RS) determined according to the TCI state(s) indicated by a common TCI state ID is used to provide QCL Type-D indication and to determine UL transmission spatial filters across the set of configured CCs.

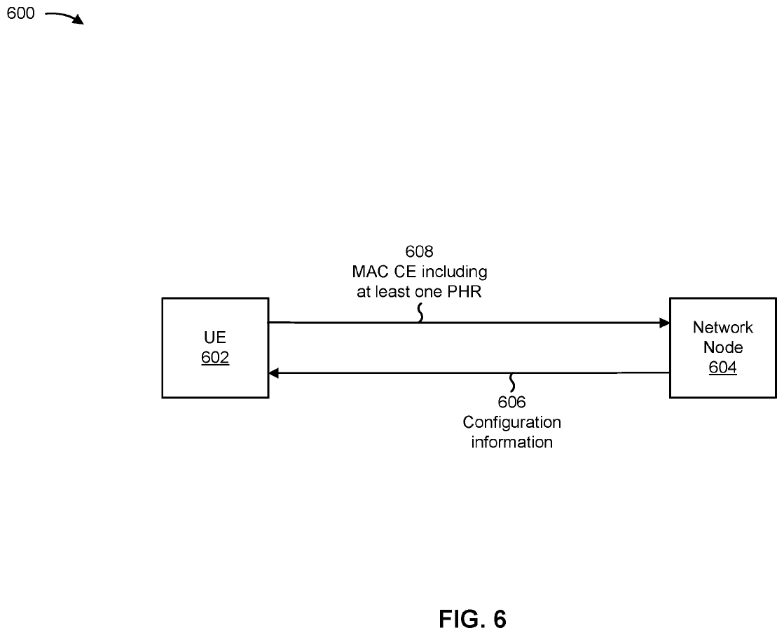

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 6-13).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 6-13).

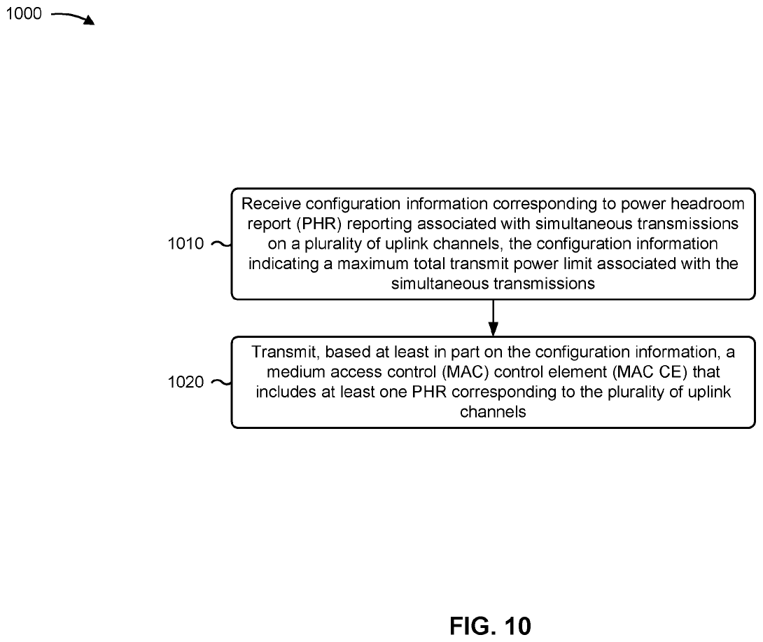

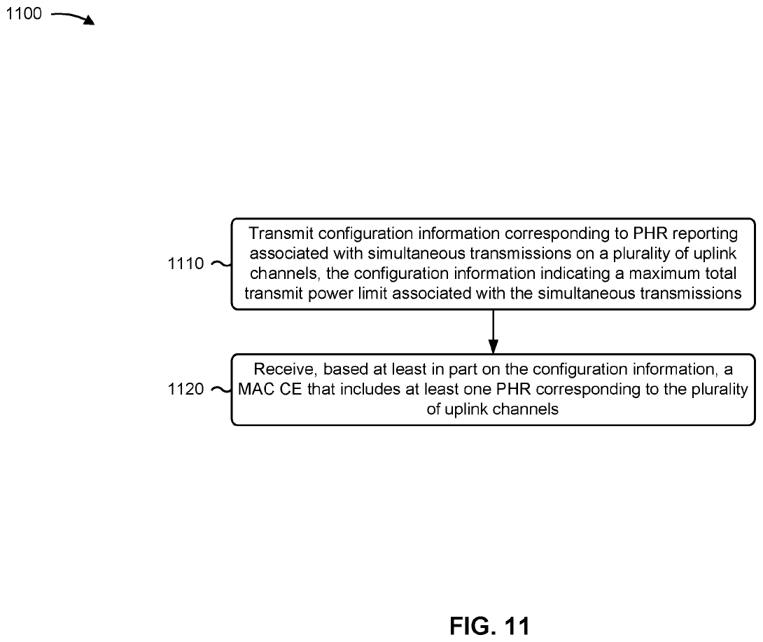

The controller/processor 240 of the network node 110, the controller/processor 280 of the UE 120, and/or any other component(s) of FIG. 2 may perform one or more techniques associated with power headroom reporting associated with simultaneous transmissions on a plurality of uplink channels, as described in more detail elsewhere herein. For example, the controller/processor 240 of the network node 110, the controller/processor 280 of the UE 120, and/or any other component(s) of FIG. 2 may perform or direct operations of, for example, process 1000 of FIG. 10, process 1100 of FIG. 11, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 1000 of FIG. 10, process 1100 of FIG. 11, and/or other processes as described herein. In some examples, executing instructions may include running the instructions, converting the instructions, compiling the instructions, and/or interpreting the instructions, among other examples.

In some aspects, a UE (e.g., the UE 120) includes means for receiving configuration information corresponding to power headroom reporting associated with simultaneous transmissions on a plurality of uplink channels, the configuration information indicating a maximum total transmit power limit associated with the simultaneous transmissions; and/or means for transmitting, based at least in part on the configuration information, a MAC CE that includes at least one PHR corresponding to the plurality of uplink channels. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node includes means for transmitting configuration information corresponding to power headroom reporting associated with simultaneous transmissions on a plurality of uplink channels, the configuration information indicating a maximum total transmit power limit associated with the simultaneous transmissions; and/or means for receiving, based at least in part on the configuration information, a MAC CE that includes at least one PHR corresponding to the plurality of uplink channels. In some aspects, the means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

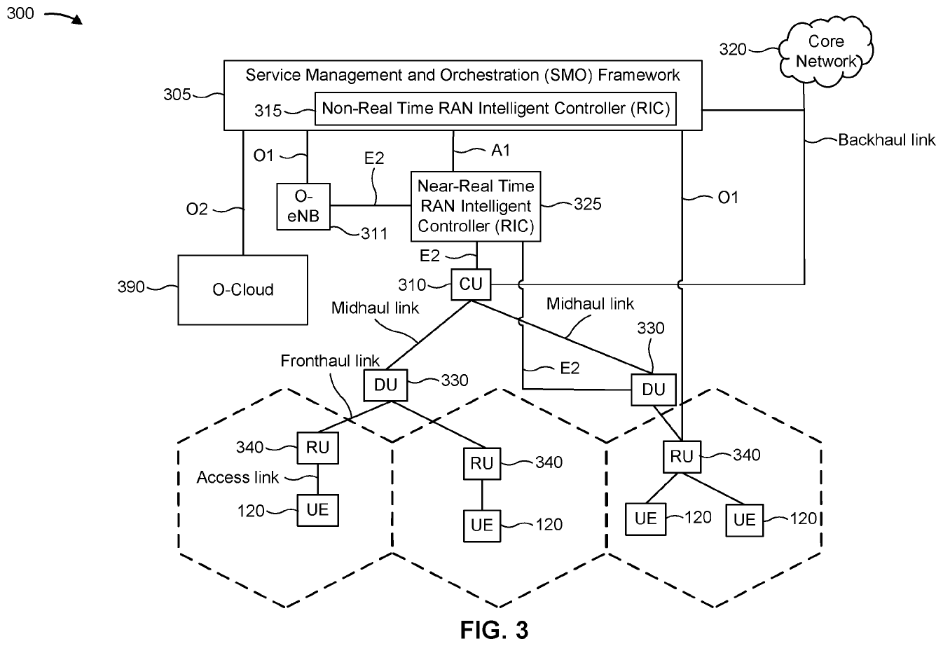

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a MAC layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

Uplink power control may determine a power for physical uplink shared channel (PUSCH), physical uplink control channel (PUCCH), sounding reference signal (SRS), and/or physical random access channel (PRACH) transmissions.

A UE may transmit a PUSCH on an active uplink bandwidth part (BWP) b of carrier f of serving cell c using a parameter set configuration with index j and a PUSCH power control adjustment state with index l. The UE may determine a PUSCH transmission power P_{PUSCH,b,f,c}(i, j, q_{d}, l) in a PUSCH transmission occasion i as:

$${P}_{PUSCH , b , f , c} ( i , j , {q}_{d} , l ) = min \{ \begin{matrix}{P}_{CMAX , f , c} ( i ) , \\ \begin{matrix}{P}_{O \_ PUSCH , b , f , c} ( j ) + 10 {log}_{10} ( {2}^{μ} \cdot {M}_{RB , b , f , c}^{PUSCH} ( i ) ) + {α}_{b , f , c} ( j ) \cdot \\ {PL}_{b , f , c} ( {q}_{d} ) + {Δ}_{TF , b , f , c} ( i , l )\end{matrix}\end{matrix} \} .$$

With respect to the PUSCH transmission power P_{PUSCH,b,f,c}(i, j, q_{d}, l) (in dB), P_{O_PUSCH,b,f,c}(j) may represent a P0 value for controlling a received power level, α_{b,f,c}(j) may represent an alpha value for partial pathloss (PL) compensation, PL_{b,f,c}(q_{d}) may represent a pathloss value based at least in part on a measured downlink reference signal with index q_{d}, Δ_{TF,b,f,c}(i) may depend on a resource allocation and an MCS of the PUSCH, and f_{b,f,c}(i, l) may represent a close loop power control based at least in part on transmit power control (TPC) commands with a closed loop index l (also referred to as a closed loop adjustment state). “RB” is an abbreviation of “resource block.”

For a PUSCH transmission, a set of uplink power control parameters may be configured. The uplink power control parameters may include a twoPUSCH-PC-AdjustmentStates parameter, which may be configured when there are two separate loops for closed loop power, and TPC commands may be applied separately for the two separate loops. The uplink power control parameters may include a set of P0 and alpha values for open-loop power control (p0-AlphaSets), where each member in the set may have an ID (p0-PUSCH-AlphaSetId: 0, 1, . . . , 29). The uplink power control parameters may include a list of pathloss reference signals, where each member of the list may have an ID (pusch-PathlossReferenceRS-Id: 0, 1, . . . , 3). The uplink power control parameters may include a list of SRI-PUSCH mappings, where “SRI” refers to an SRS reference indicator or SRS resource indicator, and each member of the list may have an ID (sri-PUSCH-PowerControlId: 0, . . . , 15). In addition, each member of the list may be configured based at least in part on an sri-PUSCH-PowerControlId parameter, which may be used as a codepoint of an SRI field in downlink control information (DCI). When a value of the SRI field in an uplink DCI scheduling PUSCH is x, then uplink power control (ULPC) parameters (e.g., PL RS, P0 and alpha, closed loop index) corresponding to an sri-PUSCH-PowerControlId equal to x may be used for the PUSCH transmission. The SRI field may be up to four bits and may indicate up to 16 values of x, depending on a configuration of the SRI field.

Because UEs can emit RF waves, microwaves, and/or other radiation, UEs are generally subject to regulatory RF safety requirements that set forth specific guidelines, or maximum permissible exposure (MPE) limits, that constrain various operations that the UEs can perform. For example, RF emissions can generally increase when a UE is transmitting, and the RF emissions can further increase in cases where the UE is performing frequent transmissions and/or high-power transmissions, among other examples. Accordingly, because frequent and/or high-power transmission can lead to significant RF emissions, regulatory agencies (e.g., the Federal Communications Commission (FCC) in the United States) provide information related to acceptable RF radiation exposure when UEs are communicating using different radio access technologies.

For example, when a UE is communicating using radio access technologies that operate in a frequency range below 6 GHz, the applicable RF exposure parameter is a specific absorption rate (SAR), which refers to a rate at which the human body absorbs energy when exposed to RF energy (e.g., power absorbed per unit of mass, which can be expressed according to watts per kilogram (W/kg)). SAR requirements generally specify that overall radiated power by a UE is to remain under a certain level to limit heating that can occur when RF energy is absorbed. In another example, when a UE is communicating using a radio access technology that operates in a high frequency range, such as a millimeter wave (mmW) frequency range, the applicable RF exposure parameter is power density, which can be regulated to limit heating of the UE and/or nearby surfaces.

Accordingly, UEs can take measures to satisfy MPE limits, which are typically regulatory requirements that are defined in terms of aggregate exposure over a certain amount of time, and the aggregate exposure can be averaged over a moving integration window (or moving time window). For example, a UE can be subject to an average power limit (Pₗᵢₘᵢₜ) that corresponds to an average power at which an MPE limit is satisfied if the UE were to transmit substantially continuously over a moving integration window of N seconds (e.g., 100 seconds). In some cases, a UE can satisfy the MPE limits by applying a power management maximum power reduction (P-MPR) to reduce the transmission power. The P-MPR can refer to a maximum allowed UE output power reduction for a serving cell. In some aspects, a UE reports a power backoff level due to the P-MPR as an MPE value.

The UE can report the P-MPR to a network node to facilitate efficient communication. The P-MPR can be reported as part of a PHR, which can be reported using a PHR MAC CE. For example, a PHR MAC CE can be a MAC CE that is enhanced to report P-MPR information. In some cases, a two-bit MPE field can be provided by reusing reserve bits to indicate the applied power backoff to meet an MPE requirement.

The PHR report also can report a PHR value, which can correspond to a difference between an actual transmit power at which the UE is operating and the maximum configured power. PHR reporting can be triggered when power backoff due to P-MPR for a cell has changed more than a threshold since the last transmission of a PHR. That threshold can be specified as a parameter phr-Tx-PowerFactorChange.

A power headroom may indicate an amount of remaining transmission power available to a UE in addition to power being used by a current transmission. The power headroom may be based at least in part on a difference between a UE maximum transmission power and a PUSCH transmission power. A PHR may be a Type 1 report for a PUSCH, a Type 3 report for an SRS, and/or a Type 2 report for a PUCCH. For example, types of UE PHRs may include a Type 1 UE power headroom that is valid for a PUSCH transmission occasion i on an active UL BWP b of carrier f of serving cell c, or a Type 3 UE power headroom that is valid for an SRS transmission occasion i on an active UL BWP b of carrier f of serving cell c. Thus, a PHR may be determined for a component carrier and/or serving cell.

A UE may determine whether a PHR for an activated serving cell is based at least in part on an actual transmission. The actual transmission may be determined based at least in part on higher layer signalling of configured grant and periodic/semi-persistent sounding reference signal transmissions, and/or DCI received by the UE. The UE may determine whether the PHR for the activated serving cell is based at least in part on a reference format. The reference format may be determined based at least in part on higher layer signalling of configured grant and periodic/semi-persistent sounding reference signal transmissions, and/or DCI received by the UE. The UE may determine whether the PHR for the activated serving cell is based at least in part on a reference format. A PHR for an activated serving cell may be referred to as a virtual PHR and/or may be provided via a virtual PHR report.

When a UE determines that a Type 1 PHR for an activated serving cell is based at least in part on an actual PUSCH transmission, for a PUSCH transmission occasion i on an active uplink BWP b of carrier f of serving cell c, the UE may compute the Type 1 PHR as:

$${P}_{PUSCH} ( i , j , {q}_{d} , l ) = {P}_{cmax , b , f , c} ( i ) - \{ {P}_{o {-}_{PUSCH} , b , f , c} ( j ) + 10 {log}_{10} ( {2}^{μ} {M}_{RB , b , f , c}^{PUSCH} ( i ) ) + {α}_{b , f , c} ( j ) {PL}_{b , f , c} ( {q}_{d} ) + {Δ}_{TF , b , f , c} ( i ) + {f}_{b , f , c} ( i , j ) \} .$$

With respect to the Type 1 PHR (in dB) based at least in part on an actual PUSCH transmission, P_{CMAX,b,f,c}(i) may represent a UE configured maximum output power after backoff due to power management (e.g., backoff due to a maximum power reduction), and P_{O_PUSCH,b,f,c}(j), M_{RB,b,f,c}^{PUSCH}(i), α_{b,f,c}(j), PL_{b,f,c}(q_{d}), Δ_{TF,b,f,c}(i) and f_{b,f,c}(i, l) may be parameters used to determine a PUSCH transmit power.

A UE may be configured with multiple component carriers for a PUSCH transmission. The PHR MAC CE may include a PHR for more than one component carrier when a multiplePHR parameter is enabled via radio resource control (RRC) signaling. Otherwise, the PHR may be a report for a primary cell (PCell) and a single-entry PHR MAC CE format may be used. When a first PUSCH in a first component carrier carries the PHR MAC CE, for a second component carrier, the PHR MAC CE may include an actual PHR or a virtual PHR (based on a reference format). When a PUSCH transmission is performed on the second component carrier at a time of power headroom reporting (e.g., in a slot of the first PUSCH), and the PUSCH transmission on the second component carrier is scheduled by DCI that satisfies a timeline condition, the PHR MAC CE may include the actual PHR. Otherwise, the MAC CE may include the virtual PHR.

The PHR MAC CE may be a single-entry PHR MAC CE or a multiple-entry PHR MAC CE. The single-entry PHR MAC CE may include a power headroom (PH) field, which may indicate a PH level for the PCell, and a P_{CMAX,f,c} field, which may indicate the P_{CMAX,f,c} used for calculating the preceding PH field. The multiple-entry PHR MAC CE may include entries for the PCell and a plurality of SCells. For example, for the PCell or a given SCell, the multiple-entry PHR MAC CE may include the corresponding PH field, the P_{CMAX,f,c} field, a “V” value which may indicate whether a PH value in the PH field corresponds to a real transmission or a reference format, and a “P” value which may indicate whether power backoff is applied due to power management.

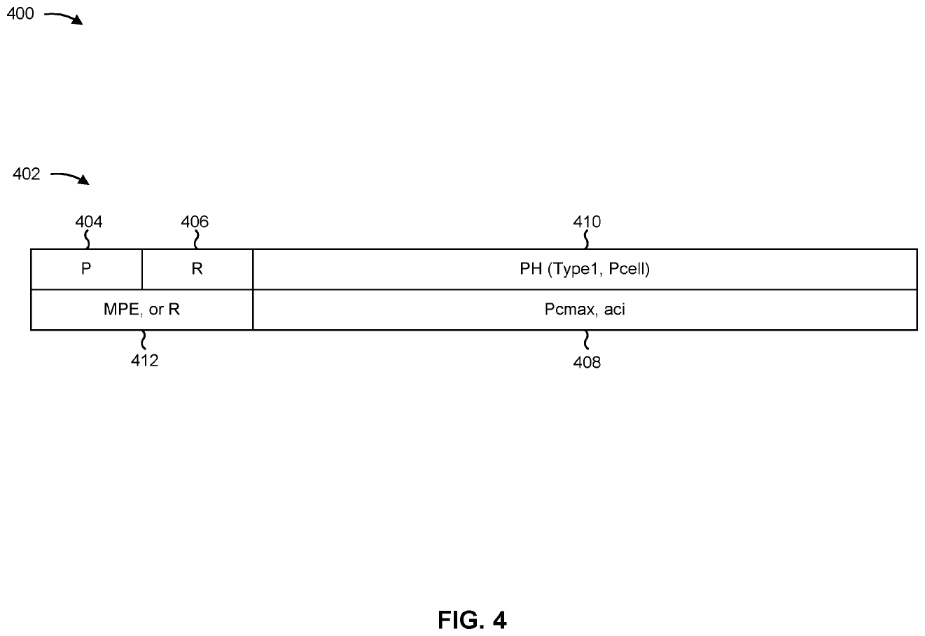

In some cases, a legacy PHR MAC CE can be used for single-cell reporting. FIG. 4 is a diagram illustrating an example 400 of single-cell MPE reporting using a PHR 402 of a MAC CE, in accordance with the present disclosure. As shown, the PHR 402 can include a power backoff indication field (referred to as a “P field” or a “P bit”) 404 that can be used to indicate a power backoff applied due to power management. In some cases, the P field 404 can be used to indicate reporting of a measured value of a P-MPR. For example, the P field can be set to a specified value (e.g., 1) if P-MPR levels are being reported, in which case the P-MPR values can be reported. If the P-MPR levels are not to be reported (e.g., if the power backoff is less than a specified value), the P field can be set to a different specified value (e.g., 0) and reserve bits (shown as “R”) 406 can be presented. In some cases, if MPE reporting is not configured, P=1 if the corresponding P_{CMAX,f,c} field 408 would have had a different value if no power backoff due to power management had been applied. The P_{CMAX,f,c} field 408 may include a value of P_{CMAX,f,c} that may represent a UE configured maximum output power after backoff due to power management (e.g., backoff due to a maximum power reduction) with respect to a carrier f of serving cell c. The PHR 402 also includes a power headroom (PH) field 410 that indicates the power headroom level. The P_{CMAX,f,c} field 408 can be used for calculating a preceding PH field. The PHR 402 also includes an MPE field 412. If MPE reporting is configured, and if the P field 404 is set to 1, the MPE field 412 indicates the applied power backoff to meet MPE requirements. The MPE field 412 indicates an index of the corresponding measured values of P-MPR levels in decibels (dB). If MPE reporting is not configured, or if the P field is set to 0, R bits are present instead.

As indicated above, FIG. 4 is provided as an example. Other examples may differ from what is described with regard to FIG. 4.

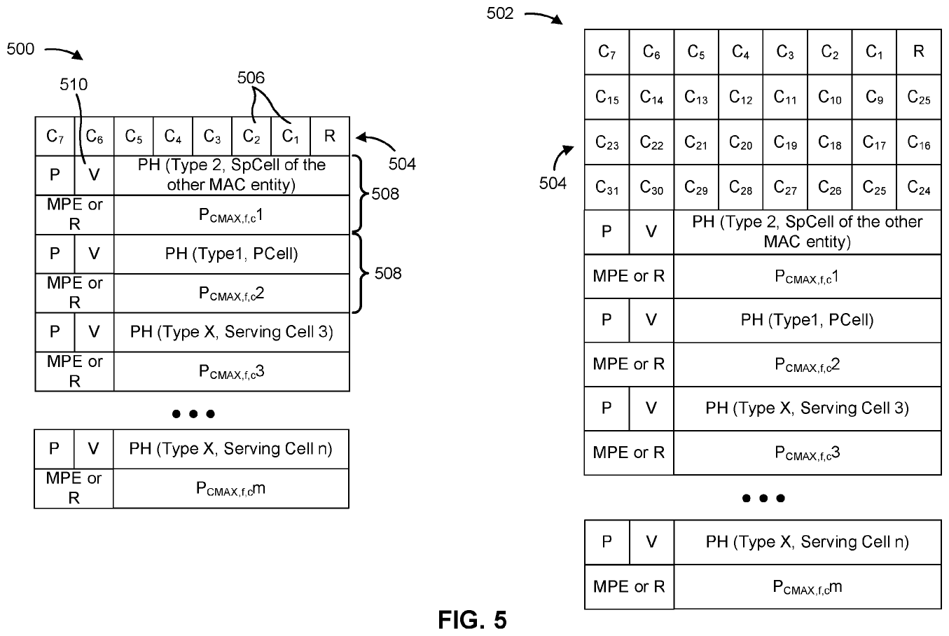

A UE may be configured with multiple component carriers for an uplink transmission. FIG. 5 is a diagram illustrating examples 500 and 502 of MPE reports for multi-cell, single-panel PHR reporting. As shown, an MPE report can include a bitmap 504 including cell activation status fields 506. Each cell activation status field 506 indicates a serving cell index, Cᵢ (shown as “C₁,” C₂,” . . . ). The cell activation status fields (known as “C fields”) 506 can indicate a serving cell and/or component carrier corresponding to a PHR 508 that is being reported.

A PHR MAC CE can include a PHR for more than one component carrier when a multiplePHR parameter is enabled via radio resource control (RRC) signaling. Otherwise, the PHR can be a report for a primary cell (PCell) and a single-entry PHR MAC CE format may be used. When a first uplink channel in a first component carrier carries the PHR MAC CE, for a second component carrier, the PHR MAC CE can include an actual PHR 508 or a virtual PHR (based on a reference format). Each PHR 508 can include a virtual PHR indication field 510 that indicates whether the corresponding PH value is based on a real transmission or a reference format. When an uplink transmission is performed on the second component carrier at a time of power headroom reporting (e.g., in a slot of the first uplink transmission), and the uplink transmission on the second component carrier is scheduled by downlink control information (DCI) that satisfies a timeline condition, the PHR MAC CE can include the actual PHR. Otherwise, the MAC CE can include the virtual PHR. For a virtual PHR, the P_{CMAX} is not reported.

The power headroom reporting described above can suffer from inefficiencies in the context of UEs equipped with multiple antenna panels and configured to communicate using MIMO techniques and/or UEs equipped to communicate via multiple component carriers. In such cases, a UE can include multiple antenna panels, each having a set of antenna ports that facilitate generating one or more beams. By reporting MPE information (e.g., P-MPR values or MPE values) per serving cell, differences in MPE information that can exist for one beam, port, and/or panel versus another beam, port and/or panel can be overlooked. Additionally, in some cases, a total transmit power limitation for all of the UE's panels can be configured. In such cases, the total transmit power can be shared across the panels. In many cases, the PHR format may not include a differentiation between maximum transmit power for different panels. As a result, a network node can be unaware of the distribution of transmit power between the panels, thereby decreasing network efficiencies and/or network performance.

Some aspects of the techniques and apparatuses described herein relate to power headroom reporting associated with simultaneous transmissions on a plurality of uplink channels. For example, in some aspects, a UE may receive configuration information corresponding to power headroom reporting associated with simultaneous transmissions on a plurality of uplink channels. The configuration information may indicate a maximum total transmit power limit associated with the simultaneous transmissions. The UE may transmit, based at least in part on the configuration information, a MAC CE that includes at least one PHR corresponding to the plurality of uplink channels. In this way, the network can be made aware of the transmit power distribution between multiple panels associated with multiple simultaneous uplink transmissions. As a result, some aspects may increase network efficiency and/or enhance overall performance, thereby having a positive impact on network performance.

As indicated above, FIG. 5 is provided as an example. Other examples may differ from what is described with regard to FIG. 5.

FIG. 6 is a diagram illustrating an example 600 associated with power headroom reporting associated with simultaneous transmissions on a plurality of uplink channels, in accordance with the present disclosure. As shown, a UE 602 and a network node 604 may communicate with one another. The UE 602 may be, be similar to, include, or be included in, the UE 120 depicted in FIGS. 1-3. The network node 604 may be, be similar to, include, or be included in, the network node 110 depicted in FIGS. 1 and 2, the CU 310 depicted in FIG. 3, the DU 330 depicted in FIG. 3, and/or the RU 340 depicted in FIG. 3.

As shown by reference number 606, the network node 604 may transmit, and the UE 602 may receive, configuration information corresponding to power headroom reporting associated with simultaneous transmissions on a plurality of uplink channels. The configuration information may indicate a maximum total transmit power limit (Pt) associated with the simultaneous transmissions. In some aspects, the configuration information may be transmitted using an RRC message. The configuration information may indicate a set of parameters to be reported. The configuration information may indicate one or more aspects associated with reporting MPE information. For example, the configuration information may indicate resources to be used for reporting power headroom information, one or more parameters to be reported, formats associated with at least one PHR, one or more MAC CE configurations to be used for at least one PHR, trigger conditions for reporting power headroom information, and/or a prohibition timer to facilitate avoiding reporting power headroom information too often, among other examples.

As shown by reference number 608, the UE 602 may transmit, and the network node 604 may receive, a MAC CE that includes at least one PHR corresponding to the plurality of uplink channels. The UE 602 may transmit the MAC CE based at least in part on the configuration information. In some aspects, the UE 602 may report two PHRs individually as if the two uplink channels are not simultaneously transmitted. For example, the at least one PHR may include a first PHR corresponding to a first uplink channel of the plurality of uplink channels and a second PHR corresponding to a second uplink channel of the plurality of uplink channels.

In some aspects, the UE 602 may assume the maximum total transmit power for each uplink channel to calculate the PHR value. For example, the first PHR may indicate a first power headroom value corresponding to the first uplink channel and the second PHR may indicate a second power headroom value corresponding to the second uplink channel. Each of the first power headroom value and the second power headroom value may be based on the maximum total transmit power limit. In some aspects, the first power headroom value may be further based on a first set of parameter values, of a set of parameters, associated with the first uplink channel. The second power headroom value may be further based on a second set of parameter values, of the set of parameters, associated with the second uplink channel. The set of parameters may include at least one of a maximum power reduction (MPR), an additional-MPR (A-MPR), a P-MPR, or an additional power adjustment parameter, ΔT_{C}.

In some aspects, the at least one PHR may indicate a first set of PHR parameter values, of a set of PHR parameters, corresponding to the first uplink channel and a second set of PHR parameter values, of the set of PHR parameters, corresponding to the second uplink channel. The set of PHR parameters may include at least one of a power headroom, a configured maximum output power (Pcmax), or a P-MPR. In some aspects, the first set of PHR parameter values may include a first Pcmax value and the second set of PHR parameter values may include a second Pcmax value. A sum of the first Pcmax value and the second Pcmax value may be less than the maximum total transmit power limit.

As indicated above, FIG. 6 is provided as an example. Other examples may differ from what is described with regard to FIG. 6.

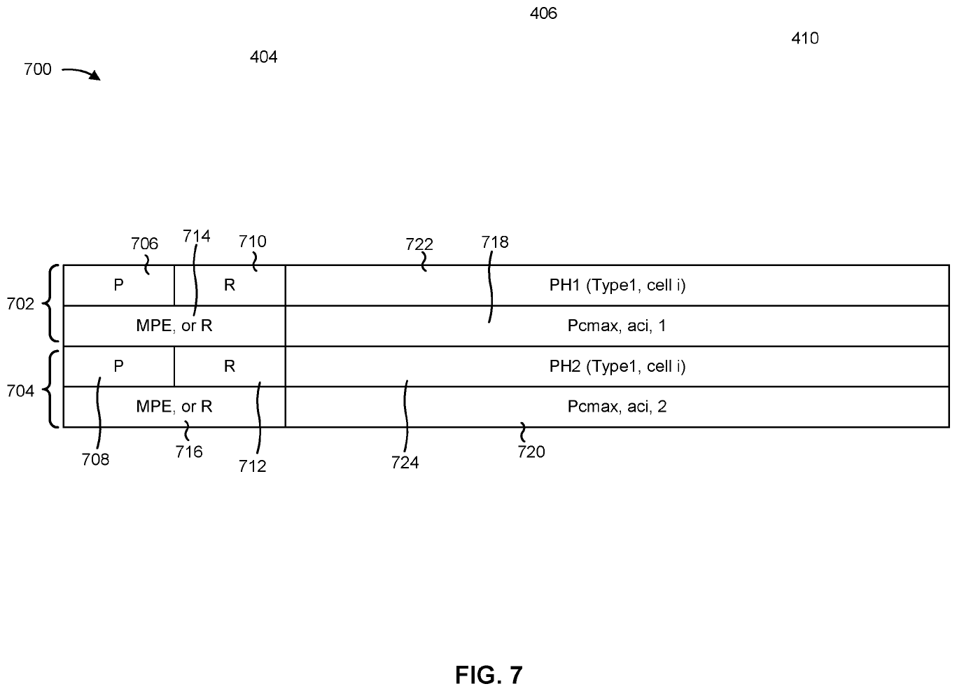

FIG. 7 is a diagram illustrating an example 700 of a MAC CE having two PHRs, in accordance with the present disclosure. Example 700 is associated with aspects described in connection with FIG. 6, in which two PHRs may be included in the MAC CE to report the power headroom information associated with two simultaneously transmitted channels individually.

The MAC CE may include a first PHR 702 corresponding to a first uplink channel and a second PHR 704 corresponding to a second uplink channel. The PHR 702 and the PHR 704 may include power backoff indication fields 706 and 708 (referred to as a “P field” or a “P bit”), respectively, that can be used to indicate a power backoff applied due to power management. The PHR 702 and the PHR 704 may include virtual indicator fields 710 and 712 (a “V field”), respectively, that indicate whether a PH value is based on a real transmission or a reference format. The PHR 702 and the PHR 704 also may include MPE fields 714 and 716, respectively, and Pcmax fields 718 and 720, respectively. As shown, the PHR 702 also includes a PH field 722 that indicates the power headroom level associated with the first uplink channel. Similarly, the PHR 704 includes a PH field 724 that indicates the power headroom level associated with the second uplink channel.

In some cases, a P field 706, 708 can be used to indicate reporting of a measured value of a P-MPR. For example, the P field 706, 708 can be set to a specified value (e.g., 1) if P-MPR levels are being reported, in which case the P-MPR values can be reported. If the P-MPR levels are not to be reported (e.g., if the power backoff is less than a specified value), the P field 706, 708 can be set to a different specified value (e.g., 0) and reserve bits (shown as “R”) can be presented. In some cases, if MPE reporting is not configured, P=1 if a corresponding P_{CMAX} field 718 or 720 would have had a different value if no power backoff due to power management had been applied. The P_{CMAX} field 718, 720 may include a value of P_{CMAX,f,c} that may represent a UE configured maximum output power after backoff due to power management (e.g., backoff due to a maximum power reduction) with respect to a carrier f of serving cell c. If MPE reporting is configured, and if the P field 706 or 708 is set to 1, the corresponding MPE field 714 or 716 may indicate the applied power backoff to meet MPE requirements. The MPE field 714 or 716 may indicate an index of the corresponding measured values of P-MPR levels in decibels. If MPE reporting is not configured, or if the P field is set to 0, R bits may be present instead.

As indicated above, FIG. 7 is provided as an example. Other examples may differ from what is described with regard to FIG. 7.

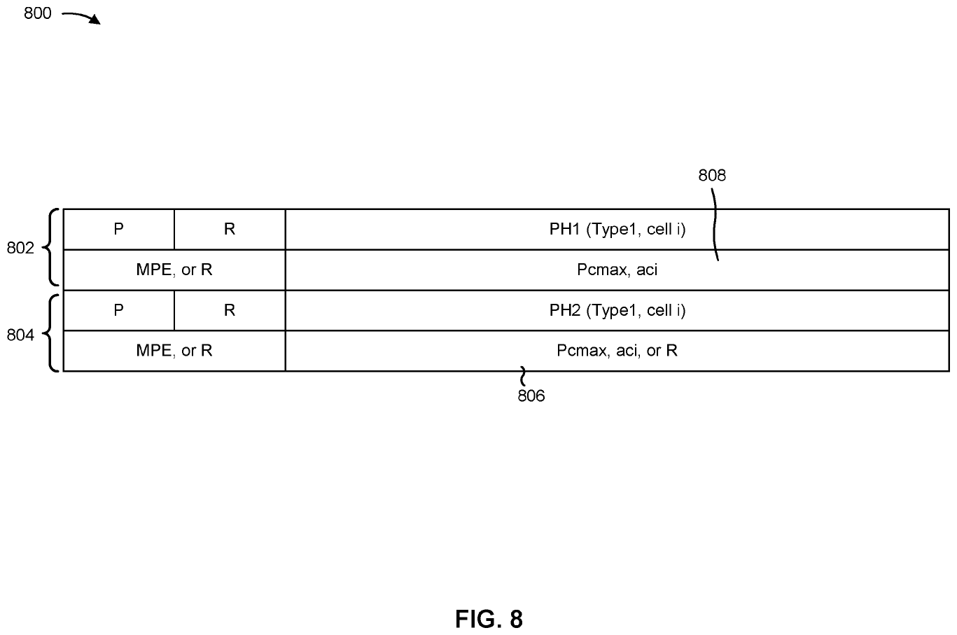

FIG. 8 is a diagram illustrating an example 800 of a MAC CE having two PHRs, in accordance with the present disclosure. Example 800 is associated with aspects described in connection with FIG. 6 and the MAC CE depicted in FIG. 7, in which two PHRs may be included in the MAC CE to report the power headroom information associated with two simultaneously transmitted channels individually. In example 800, the portion of the MAC CE shown may be the same as is shown in FIG. 7, except that the UE may report two PHRs jointly considering a reference power split of the total transmit power limit.

For example, as shown, the MAC CE may include a first PHR 802 associated with a first uplink channel and a second PHR 804 associated with a second uplink channel. The PHR 802 and the PHR 804 may include the fields described in connection with FIG. 7, with the difference that the PHR 804 may include a Pcmax field 806 that may include a reserved bit (shown as “R”) in aspects in which one configured maximum output power (Pcmax) is reported in a Pcmax field 808 associated with the PHR 802.

In some aspects, for example, the first PHR 802 may indicate a first power headroom value corresponding to the first uplink channel and the second PHR may indicate a second power headroom value corresponding to the second uplink channel, where each of the first power headroom value and the second power headroom value is based on a reference power split of the maximum total transmit power limit between the first uplink channel and the second uplink channel. For example, the maximum total transmit power limit may be split in half, each half of the maximum total transmit power limit being applied to one of the uplink channels. In some aspects, each PHR 802 and 804 may report a P_{cmax,f,c}(i) value that is computed using a half maximum total transmit power limit and using a set of MPR, A-MPR, P-MPR, DT_{C} values related to the corresponding uplink channel.

In some aspects, for example, the first power headroom value may be based on a reference power comprising half of the maximum total transmit power limit, and the second power headroom value may be based on the reference power. The UE may report two sets of PHR, P-MPR value for two uplink channels, and one P_{cmax,f,c}(i) value common for two uplink channels. For example, in some aspects, the first power headroom value may be further based on a first set of parameter values, of a set of parameters, associated with the first uplink channel, and the second power headroom value may be further based on a second set of parameter values, of the set of parameters, associated with the second uplink channel. The set of parameters may include at least one of an MPR, an A-MPR, a P-MPR, or an additional power adjustment parameter, ΔT_{C}.

In some aspects, the PHR 802 and 804 may indicate a configured maximum output power associated with the first uplink channel and the second uplink channel, and a first set of PHR parameter values, of a set of PHR parameters, corresponding to the first uplink channel and a second set of PHR parameter values, of the set of PHR parameters, corresponding to the second uplink channel. The set of PHR parameters may include at least one of a power headroom or a P-MPR.

As indicated above, FIG. 8 is provided as an example. Other examples may differ from what is described with regard to FIG. 8.

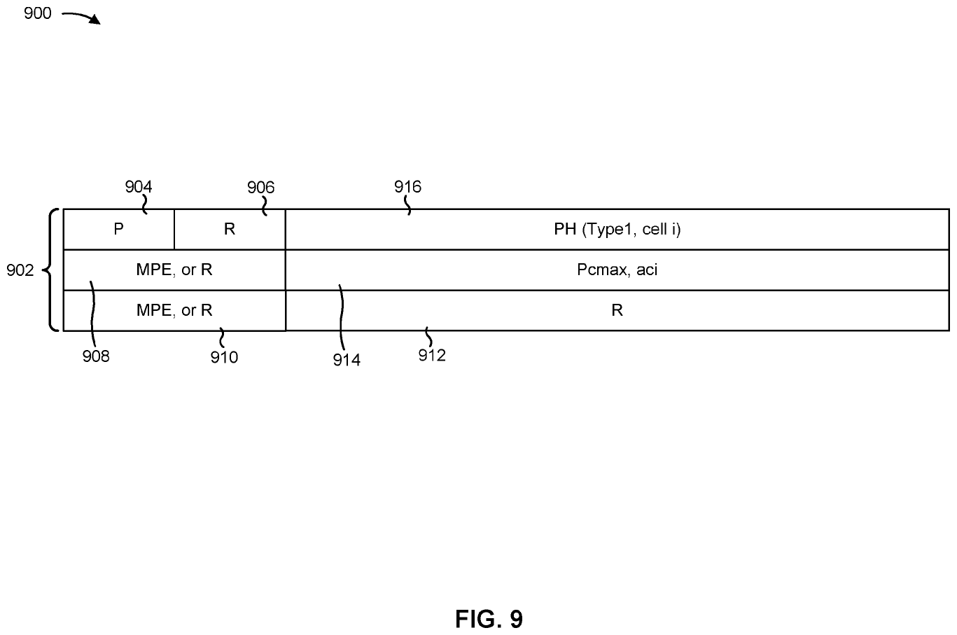

FIG. 9 is a diagram illustrating an example 900 of a MAC CE having two PHRs, in accordance with the present disclosure. Example 900 is associated with aspects described in connection with FIG. 6, in which a single PHR may be included in the MAC CE to report the power headroom information associated with two simultaneously transmitted channels.

As shown, the MAC CE may include a PHR 902 corresponding to a first uplink channel and a second uplink channel. The PHR 902 may include a power backoff indication field 904, a virtual indicator field (a “V field”) 906, a first MPE field 908 and a second MPE field 910, and a Pcmax field 914. The first MPE field 908 may be used, for example, to report P-MPR values associated with the first uplink channel and the second MPE field 910 may be used to report P-MPR values associated with the second uplink channel. A reserved field 912 may be included adjacent the second MPE field 910 since only a single Pcmax field 914 is included. As shown, the PHR 902 also may include a PH field 916.

In some aspects, for example, the PHR 902 may indicate a power headroom value corresponding to the first uplink channel and the second uplink channel, and the power headroom value may be based on the maximum total transmit power limit. In some aspects, the power headroom value may be further based on a first set of parameter values, of a set of parameters, associated with the first uplink channel, and a second set of parameter values, of the set of parameters, associated with the second uplink channel. The set of parameters comprises at least one of an MPR, an A-MPR, a P-MPR, or an additional power adjustment parameter, ΔT_{C}. The PHR 902 may indicate a first P-MPR corresponding to the first uplink channel and a second P-MPR corresponding to the second uplink channel. The PHR may further indicate a first configured maximum output power (Pcmax) value corresponding to the first uplink channel and a second Pcmax value corresponding to the second uplink channel. In some aspects, for example, assuming P_{PUSCH,b,f,c,1}(i, j, q_{d}, l) and P_{PUSCH,b,f,c,2}(i, j, q_{d}, l) are transmit powers for the first uplink channel and the second uplink channel, respectively, the single power head room may be calculated as:

$${P}_{PUSCH} ( i , j , {q}_{d} , l ) = {P}_{cmax , b , f , c} ( i ) - {P}_{PUSCH , b , f , c , 1} ( i , j , {q}_{d} , l ) - {P}_{PUSCH , b , f , c , 2} ( i , j , {q}_{d} , l ) ,$$

where the value P_{cmax,b,f,c}(i) is a maximum configured total transmit power limit computed using MPR, A-MPR, P-MPR, ΔT_{C} values related to the two respective uplink channels.

As indicated above, FIG. 9 is provided as an example. Other examples may differ from what is described with regard to FIG. 9.

FIG. 10 is a diagram illustrating an example process 1000 performed, for example, by a UE, in accordance with the present disclosure. Example process 1000 is an example where the UE (e.g., UE 602) performs operations associated with power headroom reporting associated with simultaneous transmission on a plurality of uplink channels.

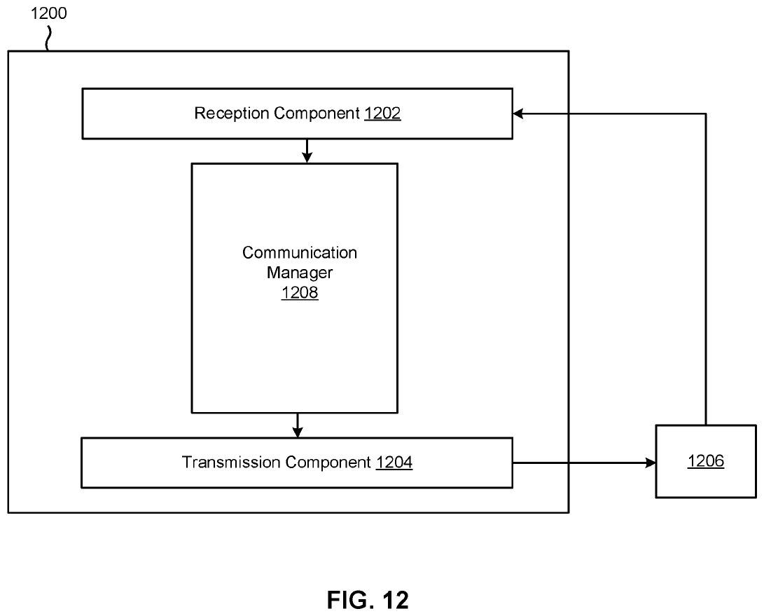

As shown in FIG. 10, in some aspects, process 1000 may include receiving configuration information corresponding to power headroom reporting associated with simultaneous transmissions on a plurality of uplink channels, the configuration information indicating a maximum total transmit power limit associated with the simultaneous transmissions (block 1010). For example, the UE (e.g., using communication manager 1208 and/or reception component 1202, depicted in FIG. 12) may receive configuration information corresponding to power headroom reporting associated with simultaneous transmissions on a plurality of uplink channels, the configuration information indicating a maximum total transmit power limit associated with the simultaneous transmissions, as described above.

As further shown in FIG. 10, in some aspects, process 1000 may include transmitting, based at least in part on the configuration information, a MAC CE that includes at least one PHR corresponding to the plurality of uplink channels (block 1020). For example, the UE (e.g., using communication manager 1208 and/or transmission component 1204, depicted in FIG. 12) may transmit, based at least in part on the configuration information, a MAC CE that includes at least one PHR corresponding to the plurality of uplink channels, as described above.

Process 1000 may include additional aspects, such as any single aspect or any combination of aspects described below and/or in connection with one or more other processes described elsewhere herein.

In a first aspect, the at least one PHR comprises a first PHR corresponding to a first uplink channel of the plurality of uplink channels and a second PHR corresponding to a second uplink channel of the plurality of uplink channels. In a second aspect, alone or in combination with the first aspect, the first PHR indicates a first power headroom value corresponding to the first uplink channel and the second PHR indicates a second power headroom value corresponding to the second uplink channel, and each of the first power headroom value and the second power headroom value is based on the maximum total transmit power limit. In a third aspect, alone or in combination with the second aspect, the first power headroom value is further based on a first set of parameter values, of a set of parameters, associated with the first uplink channel, and the second power headroom value is further based on a second set of parameter values, of the set of parameters, associated with the second uplink channel.

In a fourth aspect, alone or in combination with the third aspect, the set of parameters comprises at least one of an MPR, an A-MPR, a P-MPR, or an additional power adjustment parameter ΔT_{C}. In a fifth aspect, alone or in combination with the fourth aspect, the PHR indicates a first set of PHR parameter values, of a set of PHR parameters, corresponding to the first uplink channel and a second set of PHR parameter values, of the set of PHR parameters, corresponding to the second uplink channel. In a sixth aspect, alone or in combination with the fifth aspect, the set of PHR parameters comprises at least one of a power headroom, a configured maximum output power Pcmax, or a P-MPR. In a seventh aspect, alone or in combination with the sixth aspect, the first set of PHR parameter values comprises a first Pcmax value and the second set of PHR parameter values comprises a second Pcmax value, and a sum of the first Pcmax value and the second Pcmax value is less than the maximum total transmit power limit.

In an eighth aspect, alone or in combination with one or more of the first through seventh aspects, the first PHR indicates a first power headroom value corresponding to the first uplink channel and the second PHR indicates a second power headroom value corresponding to the second uplink channel, and each of the first power headroom value and the second power headroom value is based on a reference power split of the maximum total transmit power limit between the first uplink channel and the second uplink channel. In a ninth aspect, alone or in combination with the eighth aspect, the first power headroom value is based on a reference power comprising a half of the maximum total transmit power limit, and the second power headroom value is based on the reference power.

In a tenth aspect, alone or in combination with one or more of the eighth or ninth aspects, the first power headroom value is further based on a first set of parameter values, of a set of parameters, associated with the first uplink channel, and the second power headroom value is further based on a second set of parameter values, of the set of parameters, associated with the second uplink channel. In an eleventh aspect, alone or in combination with the tenth aspect, the set of parameters comprises at least one of an MPR, an A-MPR, a P-MPR, or an additional power adjustment parameter ΔT_{C}. In a twelfth aspect, alone or in combination with the eleventh aspect, the PHR indicates a configured maximum output power associated with the first uplink channel and the second uplink channel, and a first set of PHR parameter values, of a set of PHR parameters, corresponding to the first uplink channel and a second set of PHR parameter values, of the set of PHR parameters, corresponding to the second uplink channel. In a thirteenth aspect, alone or in combination with the twelfth aspect, the set of PHR parameters comprises at least one of a power headroom or a P-MPR.

In a fourteenth aspect, the at least one PHR comprises only one PHR corresponding to a first uplink channel of the plurality of uplink channels and a second uplink channel of the plurality of uplink channels. In a fifteenth aspect, alone or in combination with the fourteenth aspect, the first PHR indicates a power headroom value corresponding to the first uplink channel and the second uplink channel, and the power headroom value is based on the maximum total transmit power limit. In a sixteenth aspect, alone or in combination with the fifteenth aspect, the power headroom value is further based on a first set of parameter values, of a set of parameters, associated with the first uplink channel, and a second set of parameter values, of the set of parameters, associated with the second uplink channel.

In a seventeenth aspect, alone or in combination with the sixteenth aspect, the set of parameters comprises at least one of an MPR, an A-MPR, a P-MPR, or an additional power adjustment parameter ΔT_{C}. In an eighteenth aspect, alone or in combination with the seventeenth aspect, the PHR indicates a first P-MPR corresponding to the first uplink channel and a second P-MPR corresponding to the second uplink channel. In a nineteenth aspect, alone or in combination with the eighteenth aspect, the PHR further indicates a first configured maximum output power Pcmax value corresponding to the first uplink channel and a second Pcmax value corresponding to the second uplink channel.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, by a network node, in accordance with the present disclosure. Example process 1100 is an example where the network node (e.g., network node 604) performs operations associated with power headroom reporting associated with simultaneous transmission on a plurality of uplink channels.

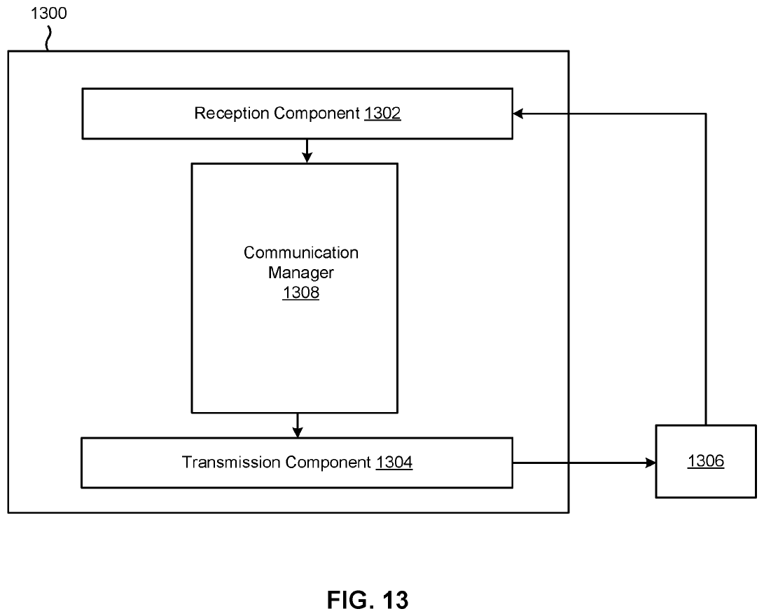

As shown in FIG. 11, in some aspects, process 1100 may include transmitting configuration information corresponding to power headroom reporting associated with simultaneous transmissions on a plurality of uplink channels, the configuration information indicating a maximum total transmit power limit associated with the simultaneous transmissions (block 1110). For example, the network node (e.g., using communication manager 1308 and/or transmission component 1304, depicted in FIG. 13) may transmit configuration information corresponding to power headroom reporting associated with simultaneous transmissions on a plurality of uplink channels, the configuration information indicating a maximum total transmit power limit associated with the simultaneous transmissions, as described above.

As further shown in FIG. 11, in some aspects, process 1100 may include receiving, based at least in part on the configuration information, a MAC CE that includes at least one PHR corresponding to the plurality of uplink channels (block 1120). For example, the network node (e.g., using communication manager 1308 and/or reception component 1302, depicted in FIG. 13) may receive, based at least in part on the configuration information, a MAC CE that includes at least one PHR corresponding to the plurality of uplink channels, as described above.

Process 1100 may include additional aspects, such as any single aspect or any combination of aspects described below and/or in connection with one or more other processes described elsewhere herein.

In a first aspect, the at least one PHR comprises a first PHR corresponding to a first uplink channel of the plurality of uplink channels and a second PHR corresponding to a second uplink channel of the plurality of uplink channels. In a second aspect, alone or in combination with the first aspect, the first PHR indicates a first power headroom value corresponding to the first uplink channel and the second PHR indicates a second power headroom value corresponding to the second uplink channel, and each of the first power headroom value and the second power headroom value is based on the maximum total transmit power limit. In a third aspect, alone or in combination with the second aspect, the first power headroom value is further based on a first set of parameter values, of a set of parameters, associated with the first uplink channel, and the second power headroom value is further based on a second set of parameter values, of the set of parameters, associated with the second uplink channel.

In a fourth aspect, alone or in combination with the third aspect, the set of parameters comprises at least one of an MPR, an A-MPR, a P-MPR, or an additional power adjustment parameter ΔT_{C}. In a fifth aspect, alone or in combination with the fourth aspect, the PHR indicates a first set of PHR parameter values, of a set of PHR parameters, corresponding to the first uplink channel and a second set of PHR parameter values, of the set of PHR parameters, corresponding to the second uplink channel. In a sixth aspect, alone or in combination with the fifth aspect, the set of PHR parameters comprises at least one of a power headroom, a configured maximum output power Pcmax, or a P-MPR. In a seventh aspect, alone or in combination with the sixth aspect, the first set of PHR parameter values comprises a first Pcmax value and the second set of PHR parameter values comprises a second Pcmax value, and a sum of the first Pcmax value and the second Pcmax value is less than the maximum total transmit power limit.

In an eighth aspect, alone or in combination with one or more of the first through seventh aspects, the first PHR indicates a first power headroom value corresponding to the first uplink channel and the second PHR indicates a second power headroom value corresponding to the second uplink channel, and each of the first power headroom value and the second power headroom value is based on a reference power split of the maximum total transmit power limit between the first uplink channel and the second uplink channel. In a ninth aspect, alone or in combination with the eighth aspect, the first power headroom value is based on a reference power comprising a half of the maximum total transmit power limit, and the second power headroom value is based on the reference power. In a tenth aspect, alone or in combination with one or more of the eighth or ninth aspects, the first power headroom value is further based on a first set of parameter values, of a set of parameters, associated with the first uplink channel, and the second power headroom value is further based on a second set of parameter values, of the set of parameters, associated with the second uplink channel.

In an eleventh aspect, alone or in combination with the tenth aspect, the set of parameters comprises at least one of an MPR, an A-MPR, a P-MPR, or an additional power adjustment parameter ΔT_{C}. In a twelfth aspect, alone or in combination with the eleventh aspect, the PHR indicates a configured maximum output power associated with the first uplink channel and the second uplink channel, and a first set of PHR parameter values, of a set of PHR parameters, corresponding to the first uplink channel and a second set of PHR parameter values, of the set of PHR parameters, corresponding to the second uplink channel. In a thirteenth aspect, alone or in combination with the twelfth aspect, the set of PHR parameters comprises at least one of a power headroom or a P-MPR.

In a fourteenth aspect, the at least one PHR comprises only one PHR corresponding to a first uplink channel of the plurality of uplink channels and a second uplink channel of the plurality of uplink channels. In a fifteenth aspect, alone or in combination with the fourteenth aspect, the first PHR indicates a power headroom value corresponding to the first uplink channel and the second uplink channel, and the power headroom value is based on the maximum total transmit power limit. In a sixteenth aspect, alone or in combination with the fifteenth aspect, the power headroom value is further based on a first set of parameter values, of a set of parameters, associated with the first uplink channel, and a second set of parameter values, of the set of parameters, associated with the second uplink channel. In a seventeenth aspect, alone or in combination with the sixteenth aspect, the set of parameters comprises at least one of an MPR, an A-MPR, a P-MPR, or an additional power adjustment parameter ΔT_{C}. In an eighteenth aspect, alone or in combination with the seventeenth aspect, the PHR indicates a first P-MPR corresponding to the first uplink channel and a second P-MPR corresponding to the second uplink channel. In a nineteenth aspect, alone or in combination with the eighteenth aspect, the PHR further indicates a first configured maximum output power Pcmax value corresponding to the first uplink channel and a second Pcmax value corresponding to the second uplink channel.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram of an example apparatus 1200 for wireless communication, in accordance with the present disclosure. The apparatus 1200 may be a UE, or a UE may include the apparatus 1200. In some aspects, the apparatus 1200 includes a reception component 1202 and a transmission component 1204, which may be in communication with one another (for example, via one or more buses and/or one or more other components). As shown, the apparatus 1200 may communicate with another apparatus 1206 (such as a UE, a base station, or another wireless communication device) using the reception component 1202 and the transmission component 1204. As further shown, the apparatus 1200 may include a communication manager 1208.

In some aspects, the apparatus 1200 may be configured to perform one or more operations described herein in connection with FIGS. 6-9. Additionally, or alternatively, the apparatus 1200 may be configured to perform one or more processes described herein, such as process 1000 of FIG. 10. In some aspects, the apparatus 1200 and/or one or more components shown in FIG. 12 may include one or more components of the UE described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1206. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, a modem, a demodulator, a MIMO detector, a receive processor, a controller/processor, a memory, or a combination thereof, of the UE described in connection with FIG. 2.

The transmission component 1204 may transmit communications, such as reference signals, control information, data communications, or a combination thereof, to the apparatus 1206. In some aspects, one or more other components of the apparatus 1200 may generate communications and may provide the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, a modem, a modulator, a transmit MIMO processor, a transmit processor, a controller/processor, a memory, or a combination thereof, of the UE described in connection with FIG. 2. In some aspects, the transmission component 1204 may be co-located with the reception component 1202 in a transceiver.

The communication manager 1208 and/or the reception component 1202 may receive configuration information corresponding to power headroom reporting associated with simultaneous transmissions on a plurality of uplink channels, the configuration information indicating a maximum total transmit power limit associated with the simultaneous transmissions. The communication manager 1208 and/or the transmission component 1204 may transmit, based at least in part on the configuration information, a MAC CE that includes at least one PHR corresponding to the plurality of uplink channels.

In some aspects, the communication manager 1208 may include one or more antennas, a modem, a controller/processor, a memory, or a combination thereof, of the UE described in connection with FIG. 2. In some aspects, the communication manager 1208 may include the reception component 1202 and/or the transmission component 1204. In some aspects, the communication manager 1208 may be, be similar to, include, or be included in, the communication manager 140 depicted in FIGS. 1 and 2.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

FIG. 13 is a diagram of an example apparatus 1300 for wireless communication, in accordance with the present disclosure. The apparatus 1300 may be a network node, or a network node may include the apparatus 1300. In some aspects, the apparatus 1300 includes a reception component 1302 and a transmission component 1304, which may be in communication with one another (for example, via one or more buses and/or one or more other components). As shown, the apparatus 1300 may communicate with another apparatus 1306 (such as a UE, a base station, or another wireless communication device) using the reception component 1302 and the transmission component 1304. As further shown, the apparatus 1300 may include a communication manager 1308.

In some aspects, the apparatus 1300 may be configured to perform one or more operations described herein in connection with FIGS. 6-9. Additionally, or alternatively, the apparatus 1300 may be configured to perform one or more processes described herein, such as process 1100 of FIG. 11. In some aspects, the apparatus 1300 and/or one or more components shown in FIG. 13 may include one or more components of the network node described in connection with FIG. 2. Additionally, or alternatively, one or more components shown in FIG. 13 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1302 may receive communications, such as reference signals, control information, data communications, or a combination thereof, from the apparatus 1306. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, a modem, a demodulator, a MIMO detector, a receive processor, a controller/processor, a memory, or a combination thereof, of the network node described in connection with FIG. 2.

The transmission component 1304 may transmit communications, such as reference signals, control information, data communications, or a combination thereof, to the apparatus 1306. In some aspects, one or more other components of the apparatus 1300 may generate communications and may provide the generated communications to the transmission component 1304 for transmission to the apparatus 1306. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1306. In some aspects, the transmission component 1304 may include one or more antennas, a modem, a modulator, a transmit MIMO processor, a transmit processor, a controller/processor, a memory, or a combination thereof, of the network node described in connection with FIG. 2. In some aspects, the transmission component 1304 may be co-located with the reception component 1302 in a transceiver.

The communication manager 1308 and/or the transmission component 1304 may transmit configuration information corresponding to power headroom reporting associated with simultaneous transmissions on a plurality of uplink channels, the configuration information indicating a maximum total transmit power limit associated with the simultaneous transmissions. The communication manager 1308 and/or the reception component 1302 may receive, based at least in part on the configuration information, a MAC CE that includes at least one PHR corresponding to the plurality of uplink channels.

In some aspects, the communication manager 1308 may include one or more antennas, a modem, a controller/processor, a memory, or a combination thereof, of the network node described in connection with FIG. 2. In some aspects, the communication manager 1308 may include the reception component 1302 and/or the transmission component 1304. In some aspects, the communication manager 1308 may be, be similar to, include, or be included in, the communication manager 150 depicted in FIGS. 1 and 2.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

The following provides an overview of some Aspects of the present disclosure:

Aspect 1: A method of wireless communication performed by a user equipment (UE), comprising: receiving configuration information corresponding to power headroom reporting associated with simultaneous transmissions on a plurality of uplink channels, the configuration information indicating a maximum total transmit power limit associated with the simultaneous transmissions; and transmitting, based at least in part on the configuration information, a medium access control (MAC) control element (MAC CE) that includes at least one power headroom report (PHR) corresponding to the plurality of uplink channels.

Aspect 2: The method of Aspect 1, wherein the at least one PHR comprises a first PHR corresponding to a first uplink channel of the plurality of uplink channels and a second PHR corresponding to a second uplink channel of the plurality of uplink channels.

Aspect 3: The method of Aspect 2, wherein the first PHR indicates a first power headroom value corresponding to the first uplink channel and the second PHR indicates a second power headroom value corresponding to the second uplink channel, and wherein each of the first power headroom value and the second power headroom value is based on the maximum total transmit power limit.

Aspect 4: The method of Aspect 3, wherein the first power headroom value is further based on a first set of parameter values, of a set of parameters, associated with the first uplink channel, and wherein the second power headroom value is further based on a second set of parameter values, of the set of parameters, associated with the second uplink channel.

Aspect 5: The method of Aspect 4, wherein the set of parameters comprises at least one of a maximum power reduction (MPR), an additional-MPR, a power management-MPR (P-MPR), or an additional power adjustment parameter.

Aspect 6: The method of Aspect 5, wherein the PHR indicates a first set of PHR parameter values, of a set of PHR parameters, corresponding to the first uplink channel and a second set of PHR parameter values, of the set of PHR parameters, corresponding to the second uplink channel.

Aspect 7: The method of Aspect 6, wherein the set of PHR parameters comprises at least one of a power headroom, a configured maximum output power (Pcmax), or a P-MPR.

Aspect 8: The method of Aspect 7, wherein the first set of PHR parameter values comprises a first Pcmax value and the second set of PHR parameter values comprises a second Pcmax value, and wherein a sum of the first Pcmax value and the second Pcmax value is less than the maximum total transmit power limit.

Aspect 9: The method of any of Aspects 2-8, wherein the first PHR indicates a first power headroom value corresponding to the first uplink channel and the second PHR indicates a second power headroom value corresponding to the second uplink channel, and wherein each of the first power headroom value and the second power headroom value is based on a reference power split of the maximum total transmit power limit between the first uplink channel and the second uplink channel.

Aspect 10: The method of Aspect 9, wherein the first power headroom value is based on a reference power comprising a half of the maximum total transmit power limit, and wherein the second power headroom value is based on the reference power.

Aspect 11: The method of either of Aspects 9 or 10, wherein the first power headroom value is further based on a first set of parameter values, of a set of parameters, associated with the first uplink channel, and wherein the second power headroom value is further based on a second set of parameter values, of the set of parameters, associated with the second uplink channel.

Aspect 12: The method of Aspect 11, wherein the set of parameters comprises at least one of a maximum power reduction (MPR), an additional-MPR, a power management-MPR (P-MPR), or an additional power adjustment parameter.

Aspect 13: The method of Aspect 12, wherein the PHR indicates a configured maximum output power associated with the first uplink channel and the second uplink channel, and a first set of PHR parameter values, of a set of PHR parameters, corresponding to the first uplink channel and a second set of PHR parameter values, of the set of PHR parameters, corresponding to the second uplink channel.

Aspect 14: The method of Aspect 13, wherein the set of PHR parameters comprises at least one of a power headroom or a P-MPR.

Aspect 15: The method of Aspect 1, wherein the at least one PHR comprises only one PHR corresponding to a first uplink channel of the plurality of uplink channels and a second uplink channel of the plurality of uplink channels.

Aspect 16: The method of Aspect 15, wherein the first PHR indicates a power headroom value corresponding to the first uplink channel and the second uplink channel, and wherein the power headroom value is based on the maximum total transmit power limit.

Aspect 17: The method of Aspect 16, wherein the power headroom value is further based on a first set of parameter values, of a set of parameters, associated with the first uplink channel, and a second set of parameter values, of the set of parameters, associated with the second uplink channel.

Aspect 18: The method of Aspect 17, wherein the set of parameters comprises at least one of a maximum power reduction (MPR), an additional-MPR, a power management-MPR (P-MPR), or an additional power adjustment parameter.

Aspect 19: The method of Aspect 18, wherein the PHR indicates a first P-MPR corresponding to the first uplink channel and a second P-MPR corresponding to the second uplink channel.

Aspect 20: The method of Aspect 19, wherein the PHR further indicates a first configured maximum output power (Pcmax) value corresponding to the first uplink channel and a second Pcmax value corresponding to the second uplink channel.

Aspect 21: A method of wireless communication performed by a network node, comprising: transmitting configuration information corresponding to power headroom reporting associated with simultaneous transmissions on a plurality of uplink channels, the configuration information indicating a maximum total transmit power limit associated with the simultaneous transmissions; and receiving, based at least in part on the configuration information, a medium access control (MAC) control element (MAC CE) that includes at least one power headroom report (PHR) corresponding to the plurality of uplink channels.

Aspect 22: The method of Aspect 21, wherein the at least one PHR comprises a first PHR corresponding to a first uplink channel of the plurality of uplink channels and a second PHR corresponding to a second uplink channel of the plurality of uplink channels.

Aspect 23: The method of Aspect 22, wherein the first PHR indicates a first power headroom value corresponding to the first uplink channel and the second PHR indicates a second power headroom value corresponding to the second uplink channel, and wherein each of the first power headroom value and the second power headroom value is based on the maximum total transmit power limit.

Aspect 24: The method of Aspect 23, wherein the first power headroom value is further based on a first set of parameter values, of a set of parameters, associated with the first uplink channel, and wherein the second power headroom value is further based on a second set of parameter values, of the set of parameters, associated with the second uplink channel.

Aspect 25: The method of Aspect 24, wherein the set of parameters comprises at least one of a maximum power reduction (MPR), an additional-MPR, a power management-MPR (P-MPR), or an additional power adjustment parameter.

Aspect 26: The method of Aspect 25, wherein the PHR indicates a first set of PHR parameter values, of a set of PHR parameters, corresponding to the first uplink channel and a second set of PHR parameter values, of the set of PHR parameters, corresponding to the second uplink channel.

Aspect 27: The method of Aspect 26, wherein the set of PHR parameters comprises at least one of a power headroom, a configured maximum output power (Pcmax), or a P-MPR.

Aspect 28: The method of Aspect 27, wherein the first set of PHR parameter values comprises a first Pcmax value and the second set of PHR parameter values comprises a second Pcmax value, and wherein a sum of the first Pcmax value and the second Pcmax value is less than the maximum total transmit power limit.

Aspect 29: The method of any of Aspects 22-28, wherein the first PHR indicates a first power headroom value corresponding to the first uplink channel and the second PHR indicates a second power headroom value corresponding to the second uplink channel, and wherein each of the first power headroom value and the second power headroom value is based on a reference power split of the maximum total transmit power limit between the first uplink channel and the second uplink channel.

Aspect 30: The method of Aspect 29, wherein the first power headroom value is based on a reference power comprising a half of the maximum total transmit power limit, and wherein the second power headroom value is based on the reference power.

Aspect 31: The method of either of Aspects 29 or 30, wherein the first power headroom value is further based on a first set of parameter values, of a set of parameters, associated with the first uplink channel, and wherein the second power headroom value is further based on a second set of parameter values, of the set of parameters, associated with the second uplink channel.

Aspect 32: The method of Aspect 31, wherein the set of parameters comprises at least one of a maximum power reduction (MPR), an additional-MPR, a power management-MPR (P-MPR), or an additional power adjustment parameter.

Aspect 33: The method of Aspect 32, wherein the PHR indicates a configured maximum output power associated with the first uplink channel and the second uplink channel, and a first set of PHR parameter values, of a set of PHR parameters, corresponding to the first uplink channel and a second set of PHR parameter values, of the set of PHR parameters, corresponding to the second uplink channel.

Aspect 34: The method of Aspect 33, wherein the set of PHR parameters comprises at least one of a power headroom or a P-MPR.

Aspect 35: The method of Aspect 21, wherein the at least one PHR comprises only one PHR corresponding to a first uplink channel of the plurality of uplink channels and a second uplink channel of the plurality of uplink channels.

Aspect 36: The method of Aspect 35, wherein the first PHR indicates a power headroom value corresponding to the first uplink channel and the second uplink channel, and wherein the power headroom value is based on the maximum total transmit power limit.

Aspect 37: The method of Aspect 36, wherein the power headroom value is further based on a first set of parameter values, of a set of parameters, associated with the first uplink channel, and a second set of parameter values, of the set of parameters, associated with the second uplink channel.

Aspect 38: The method of Aspect 37, wherein the set of parameters comprises at least one of a maximum power reduction (MPR), an additional-MPR, a power management-MPR (P-MPR), or an additional power adjustment parameter.

Aspect 39: The method of Aspect 38, wherein the PHR indicates a first P-MPR corresponding to the first uplink channel and a second P-MPR corresponding to the second uplink channel.

Aspect 40: The method of Aspect 39, wherein the PHR further indicates a first configured maximum output power (Pcmax) value corresponding to the first uplink channel and a second Pcmax value corresponding to the second uplink channel.

Aspect 41: An apparatus for wireless communication at a device, comprising a processor; memory coupled with the processor; and instructions stored in the memory and executable by the processor to cause the apparatus to perform the method of one or more of Aspects 1-20.

Aspect 42: A device for wireless communication, comprising a memory and one or more processors coupled to the memory, the one or more processors configured to perform the method of one or more of Aspects 1-20.

Aspect 43: An apparatus for wireless communication, comprising at least one means for performing the method of one or more of Aspects 1-20.

Aspect 44: A non-transitory computer-readable medium storing code for wireless communication, the code comprising instructions executable by a processor to perform the method of one or more of Aspects 1-20.

Aspect 45: A non-transitory computer-readable medium storing a set of instructions for wireless communication, the set of instructions comprising one or more instructions that, when executed by one or more processors of a device, cause the device to perform the method of one or more of Aspects 1-20.

Aspect 46: An apparatus for wireless communication at a device, comprising a processor; memory coupled with the processor; and instructions stored in the memory and executable by the processor to cause the apparatus to perform the method of one or more of Aspects 21-40.

Aspect 47: A device for wireless communication, comprising a memory and one or more processors coupled to the memory, the one or more processors configured to perform the method of one or more of Aspects 21-40.

Aspect 48: An apparatus for wireless communication, comprising at least one means for performing the method of one or more of Aspects 21-40.

Aspect 49: A non-transitory computer-readable medium storing code for wireless communication, the code comprising instructions executable by a processor to perform the method of one or more of Aspects 21-40.

Aspect 50: A non-transitory computer-readable medium storing a set of instructions for wireless communication, the set of instructions comprising one or more instructions that, when executed by one or more processors of a device, cause the device to perform the method of one or more of Aspects 21-40.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors, coupled to the memory, configured to:
receive configuration information corresponding to power headroom reporting associated with simultaneous transmissions on a plurality of uplink channels, the configuration information indicating a maximum total transmit power limit associated with the simultaneous transmissions; and
transmit, based at least in part on the configuration information, a medium access control (MAC) control element (MAC CE) that includes at least one power headroom report (PHR) corresponding to the plurality of uplink channels.

2. The UE of claim 1, wherein the at least one PHR comprises a first PHR corresponding to a first uplink channel of the plurality of uplink channels and a second PHR corresponding to a second uplink channel of the plurality of uplink channels.

3. The UE of claim 2, wherein the first PHR indicates a first power headroom value corresponding to the first uplink channel and the second PHR indicates a second power headroom value corresponding to the second uplink channel, and wherein each of the first power headroom value and the second power headroom value is based on the maximum total transmit power limit.

4. The UE of claim 3, wherein the first power headroom value is further based on a first set of parameter values, of a set of parameters, associated with the first uplink channel, and wherein the second power headroom value is further based on a second set of parameter values, of the set of parameters, associated with the second uplink channel.

5. The UE of claim 4, wherein the set of parameters comprises at least one of a maximum power reduction (MPR), an additional-MPR, a power management-MPR (P-MPR), or an additional power adjustment parameter.

6. The UE of claim 5, wherein the PHR indicates a first set of PHR parameter values, of a set of PHR parameters, corresponding to the first uplink channel and a second set of PHR parameter values, of the set of PHR parameters, corresponding to the second uplink channel.

7. The UE of claim 6, wherein the set of PHR parameters comprises at least one of a power headroom, a configured maximum output power (Pcmax), or a P-MPR.

8. The UE of claim 7, wherein the first set of PHR parameter values comprises a first Pcmax value and the second set of PHR parameter values comprises a second Pcmax value, and wherein a sum of the first Pcmax value and the second Pcmax value is less than the maximum total transmit power limit.

9. The UE of claim 2, wherein the first PHR indicates a first power headroom value corresponding to the first uplink channel and the second PHR indicates a second power headroom value corresponding to the second uplink channel, and wherein each of the first power headroom value and the second power headroom value is based on a reference power split of the maximum total transmit power limit between the first uplink channel and the second uplink channel.

10. The UE of claim 9, wherein the first power headroom value is based on a reference power comprising a half of the maximum total transmit power limit, and wherein the second power headroom value is based on the reference power.

11. The UE of claim 9, wherein the first power headroom value is further based on a first set of parameter values, of a set of parameters, associated with the first uplink channel, and wherein the second power headroom value is further based on a second set of parameter values, of the set of parameters, associated with the second uplink channel.

12. The UE of claim 11, wherein the set of parameters comprises at least one of a maximum power reduction (MPR), an additional-MPR, a power management-MPR (P-MPR), or an additional power adjustment parameter.

13. The UE of claim 12, wherein the PHR indicates a configured maximum output power associated with the first uplink channel and the second uplink channel, and a first set of PHR parameter values, of a set of PHR parameters, corresponding to the first uplink channel and a second set of PHR parameter values, of the set of PHR parameters, corresponding to the second uplink channel.

14. The UE of claim 13, wherein the set of PHR parameters comprises at least one of a power headroom or a P-MPR.

15. The UE of claim 1, wherein the at least one PHR comprises only one PHR corresponding to a first uplink channel of the plurality of uplink channels and a second uplink channel of the of uplink channels.

16. The UE of claim 15, wherein the first PHR indicates a power headroom value corresponding to the first uplink channel and the second uplink channel, and wherein the power headroom value is based on the maximum total transmit power limit.

17. The UE of claim 16, wherein the power headroom value is further based on a first set of parameter values, of a set of parameters, associated with the first uplink channel, and a second set of parameter values, of the set of parameters, associated with the second uplink channel.

18. The UE of claim 17, wherein the set of parameters comprises at least one of a maximum power reduction (MPR), an additional-MPR, a power management-MPR (P-MPR), or an additional power adjustment parameter.

19. The UE of claim 18, wherein the PHR indicates a first P-MPR corresponding to the first uplink channel and a second P-MPR corresponding to the second uplink channel.

20. The UE of claim 19, wherein the PHR further indicates a first configured maximum output power (Pcmax) value corresponding to the first uplink channel and a second Pcmax value corresponding to the second uplink channel.

21. A network node for wireless communication, comprising:
a memory; and
one or more processors, coupled to the memory, configured to:
transmit configuration information corresponding to power headroom reporting associated with simultaneous transmissions on a plurality of uplink channels, the configuration information indicating a maximum total transmit power limit associated with the simultaneous transmissions; and
receive, based at least in part on the configuration information, a medium access control (MAC) control element (MAC CE) that includes at least one power headroom report (PHR) corresponding to the plurality of uplink channels.

22. The network node of claim 21, wherein the at least one PHR comprises a first PHR corresponding to a first uplink channel of the plurality of uplink channels and a second PHR corresponding to a second uplink channel of the plurality of uplink channels.

23. The network node of claim 22, wherein the first PHR indicates a first power headroom value corresponding to the first uplink channel and the second PHR indicates a second power headroom value corresponding to the second uplink channel, and wherein each of the first power headroom value and the second power headroom value is based on the maximum total transmit power limit.

24. The network node of claim 23, wherein the first power headroom value is further based on a first set of parameter values, of a set of parameters, associated with the first uplink channel, and wherein the second power headroom value is further based on a second set of parameter values, of the set of parameters, associated with the second uplink channel, wherein the set of parameters comprises at least one of a maximum power reduction (MPR), an additional-MPR, a power management-MPR (P-MPR), or an additional power adjustment parameter.

25. The network node of claim 24, wherein the PHR indicates a first set of PHR parameter values, of a set of PHR parameters, corresponding to the first uplink channel and a second set of PHR parameter values, of the set of PHR parameters, corresponding to the second uplink channel, wherein the set of PHR parameters comprises at least one of a power headroom, a configured maximum output power (Pcmax), or a P-MPR.

26. The network node of claim 21, wherein the at least one PHR comprises only one PHR corresponding to a first uplink channel of the plurality of uplink channels and a second uplink channel of the plurality of uplink channels.

27. A method of wireless communication performed by a user equipment (UE), comprising:
receiving configuration information corresponding to power headroom reporting associated with simultaneous transmissions on a plurality of uplink channels, the configuration information indicating a maximum total transmit power limit associated with the simultaneous transmissions; and
transmitting, based at least in part on the configuration information, a medium access control (MAC) control element (MAC CE) that includes at least one power headroom report (PHR) corresponding to the plurality of uplink channels.

28. The method of claim 27, wherein the at least one PHR comprises a first PHR corresponding to a first uplink channel of the plurality of uplink channels and a second PHR corresponding to a second uplink channel of the plurality of uplink channels.

29. A method of wireless communication performed by a network node, comprising:
transmitting configuration information corresponding to power headroom reporting associated with simultaneous transmissions on a plurality of uplink channels, the configuration information indicating a maximum total transmit power limit associated with the simultaneous transmissions; and
receiving, based at least in part on the configuration information, a medium access control (MAC) control element (MAC CE) that includes at least one power headroom report (PHR) corresponding to the plurality of uplink channels.

30. The method of claim 29, wherein the at least one PHR comprises a first PHR corresponding to a first uplink channel of the plurality of uplink channels and a second PHR corresponding to a second uplink channel of the plurality of uplink channels.
